(19) United States
(12) Patent Application Publication
(10) Pub. No.: US 2017/0348924 A1
(43) Pub. Date: Dec. 7, 2017

(54) ULTRASONIC DEVICE FOR QUANTIFYING THE INFLOW/OUTFLOW OF INJECTION RESIN AND METHOD IMPLEMENTING SUCH A DEVICE

(71) Applicant: AIRBUS GROUP SAS, BLAGNAC (FR)

(72) Inventor: STÉPHANE AUFFRAY, SAINT LYPHARD (FR)

(21) Appl. No.: 15/539,128

(22) PCT Filed: Dec. 18, 2015
(86) PCT No.: PCT/EP2015/080606

§ 371 Date: Jun. 22, 2017

(30) Foreign Application Priority Data
Dec. 24, 2014 (FR) 1463321

(51) Int. Cl. B29C 70/54; G01N 29/22; G01N 29/11; G01N 29/07; G01N 15/08; G01N 29/46; B29C 70/48

(52) U.S. Cl. CPC B29C 70/546; G01N 29/46; G01N 29/222; B29C 70/48; G01N 29/07; G01N 15/0826; G01N 29/11

(57) ABSTRACT

An ultrasonic device to characterize the flow of resin entering and exiting an injection mold during the phase of impregnation, by the resin, of a preform contained in the mold. The device includes two ultrasonic sensors arranged respectively in the vicinity of the inlet port where the resin enters the mold and in the vicinity of the outlet port where the resin exits the mold. Each sensor emits an ultrasonic wave towards the end of the mold in the vicinity of which it is positioned, and receives the ultrasonic wave reflected by the medium. Preferably, the device determines the stabilization of the flow of resin passing through the mold based on the signals received by the sensors. A method for implementing the device to determine the completeness of the operation of impregnating, with resin, a preform positioned in an injection mold into which the resin is introduced.

### FIELD OF THE INVENTION

The invention relates to the general field of the fabrication of composite material structures by impregnating fibrous preforms with resin, notably using the LRI (liquid resin infusion) or RTM (resin transfer molding) process. It relates more particularly to the monitoring of proper impregnation of the preform by the resin.

### BACKGROUND OF THE INVENTION

The invention relates to the field of the characterization of the injection of fibrous preforms by the LRI or RTM process.

An industrial injection system may be reduced to a piston and a mold. The latter may of constant volume (RTM mold with rigid punch and die) or variable volume (RTM-VAP or LRI mold with rigid punch and flexible membrane with or without compensation plate (or “caul plate”)).

Where the impregnation of the preform with the resin inside the mold is concerned, monitoring the completeness of the impregnation phase entails good control of the quantity of resin with which the fibrous preform is actually impregnated at a given time.

The study of the flow of the impregnation fluid (resin) entails determining the permeability of the reinforcement that is part of the composite structure.

This is determined by the injection at a constant flow rate of a liquid through a sample of the reinforcement to be characterized and measuring the pressure difference created by this injection, which measurement is stored. In this operation, the fibrous reinforcement is progressively saturated by the liquid as the resin front advances.

The basic model governing flow of this kind is governed by the DARCY law according to which:

Q=K×[A/μ]×[ΔP/L]

where here Q represents the volume flow rate of resin, A the flow section, μ the viscosity, and L the flow length.

The FIG. 1 diagram shows an injection system conventionally used for carrying out this kind of injection.

As can be seen in the figure, a system of this kind includes a resin injection monitoring device 13 positioned at the inlet of the mold 13 and an excess resin recovery monitoring device 15 at the exit from the mold. Here by excess resin is meant resin that has not been captured by the preform during its transit in the mold, for whatever reason.

The inlet device 13, connected to the fitting 11 mounted at the inlet of the mold 14, essentially includes means 131 for injecting resin at a controlled pressure and means 132 for producing a vacuum of given value in the device, the production of a vacuum in this way notably being for the purpose of impregnating the fibrous preform.

For its part, the outlet device 15 includes an inlet circuit connected to the fitting 12 mounted at the outlet of the mold 14 including an inlet valve 151 connected to a settling tank 152 and means for degassing the recovered resin, said means notably including a vacuum pump 153.

At present, there is no method of effectively quantifying the flow of resin entering or leaving the mold. The porosity introduced by incorrect degassing or leakage is not clearly identified.

In the systems generally used at present, the inflow parameters that govern the flow of the resin and its absorption by the preform (flow rate, pressure, temperature of injection, . . . ) are set points merely introduced into the system that controls the injection pressure and no further monitoring is carried out downstream of that system.

Thus, various insufficiencies are found in the systems generally used at present:
no account is taken of the porosities existing in the liquid resin, the viscosity of which is moreover imposed by the temperature;
no account is taken of the effects of the upstream and downstream resin feed channels, which induce great variation of the volume of resin to be used, which variation is difficult to quantify and essentially variable from one injection operation to another;
the arrival of the resin in the cavity of the mold is detected only by the detection of a variation of pressure at the level of the injection device;
no measurements are taken at the outlet of the mold 14 other than the visual detection of the presence of resin in the outlet channels and in the recovery device 15.

What is more, merely installing a thermocouple just ahead of the inlet into the mold does not make it possible to distinguish the thermal front from the real front of the resin as it advances inside the mold, so that there exists a real uncertainty concerning the geographical presence of the resin.

Also, the flow sensors generally installed in the body of the mold detect well the presence of resin but give no information as to its degassing state.

Also, in the context of a (variable volume) LRI structure, the lifting of the caul plate or the of the membrane of the mold is evaluated only through the variation with time of the ratio of the injected volume to the theoretical (predicted) volume. This variation is subject to errors inherent to the parameters cited above.

To alleviate these insufficiencies the injection time is generally lengthened, which in practice is reflected in a lengthening of the for which the resin is allowed to flow into the recovery device. The effect of this lengthening is to lengthen the impregnation operation and to increase the quantity of resin injected unnecessarily into the mold, which resin is in the end poured into the recovery device.

It is known from the document US2007/145622 A1 to install ultrasound type sensors in a resin injection mold but those sensors are arranged inside the mold and therefore do not make it possible to monitor and to analyze the entry flow and the exit flow of the resin.

This also applies to the document US2002/155186 A1 in which the sensors are positioned inside the mold.

### SUMMARY OF THE INVENTION

An object of the invention is to propose means for and a method for:
determining with the best possible accuracy the arrival of the resin in the mold;
monitoring the quality of degassing at the start of injection (injection of resin without bubbles);
ensuring synchronization with the monitoring tools dedicated to “material-health” monitoring, tools such as the acquisition systems of ultrasound sensors dedicated to local and multiplexed detection of the saturation of the preform, the function of which is:
to predict and to verify the completeness of the injection process (exit of resin identified and quantified on the same terms as the entry of resin into the mold);
to interact with the “material-health” monitoring tools to determine the time at which the injection operation can be stopped and the launching of the polymerization operation can begin.

To this end the invention consists in an ultrasound device for characterizing the flow of resin entering and leaving an injection mold during the phase of impregnation by said resin of a preform contained in said injection mold. The device includes two ultrasound sensors arranged respectively in the vicinity of the inlet port where the resin enters the injection mold, outside said mold, and in the vicinity of the outlet port where the resin leaves said mold. Each sensor emits an ultrasound wave towards the end of the mold in the vicinity of which it is positioned and receiving the ultrasound wave reflected by the medium.

According to one feature of the invention, the ultrasound sensors are devices integrated into the structure of the fittings for connecting the injection mold to means for injecting resin into said mold and means for recovering resin evacuated from the mold.

According to another feature, the device according to the invention also includes means for effecting the temporal analysis and/or the spectral analysis of the ultrasound wave received by each of the sensors and determining the stabilization of the flow of resin through the mold.

In one particular embodiment suited to the situation in which the injection mold includes means for monitoring inside the mold the material health of the part formed from the preform, the device according to the invention further includes means for determining the completeness of the step of impregnating the preform by combining the information supplied by the means for analyzing the reflected ultrasound waves received by the ultrasound sensors and the information supplied by the material health monitoring means.

The invention also consists in a method for determining the completeness of the operation of impregnating a preform with a resin, said preform being positioned in an injection mold into which the resin is introduced, said method employing the device according to the invention. The method includes the following steps:
a first step of launching the operation of injecting resin during which an operation of analyzing the flow of resin entering the mold is carried out;
a second step of initializing an injection start time t₀_{_}_{injection};
a third step of monitoring the injection operation, this step employing an operation of measuring the elapsed time t_{elapsed}, this injection time being
counted from the time t₀_{_}_{injection}, and comparing the elapsed time to a set point value t_{injection}.

The invention also consists in a method for determining the completeness of the operation of impregnating a preform with a resin, said preform being positioned in an injection mold into which the resin is introduced, said method employing the device according to the invention. The method includes the following steps:
a first step of launching the operation of injecting resin during which an operation of analyzing the flow of resin entering the mold is carried out;
a second step of initializing an injection start time t₀_{_}_{injection};
a third step of monitoring the injection operation, this step employing an operation of analyzing the flow of resin leaving the mold, the injection process being stopped when the exit flow of resin is stabilized.

According to one particular embodiment of the above method, the third step of monitoring the injection operation also employs an operation of analyzing the material health monitoring effected inside the module, the injection process being stopped if the flow of resin leaving the mold is stabilized and if the material health monitoring is positive.

According to an additional feature of the method according to the invention in its preceding form, the third step takes account of the elapsed time so that if, during the execution of the third step the material health monitoring remains negative while the flow of resin leaving the mold has stabilized since at least a given time lapse, the injection process is continued and then stopped at the end of a limit time lapse if, despite the lengthening of the injection operation, the material health indicator remains negative.

### DESCRIPTION OF THE FIGURES

The features and advantages of the invention will be better understood thanks to the following description, which description relies on the appended figures, which show:

FIG. 1 is a diagrammatic illustration showing a conventional injection device to which are added the elements of the device according to the invention;

FIGS. 2 and 3 are illustrations relating to a preferred embodiment of the sensors of the device according to the invention;

FIG. 4 is a flowchart describing the essential steps of the method employing the device according to the invention in a first variant;

FIG. 5 is a flowchart describing the essential steps of the method according to the invention in a second variant;

FIG. 6 is a flowchart describing the essential steps of the method according to the invention in a third variant; and

FIG. 7 is a comparative diagram highlighting the advantageous nature of the device according to the invention.

It is to be noted that in the figures appended to the present text the same reference corresponds to the same functional element or to the same function.

### DETAILED DESCRIPTION

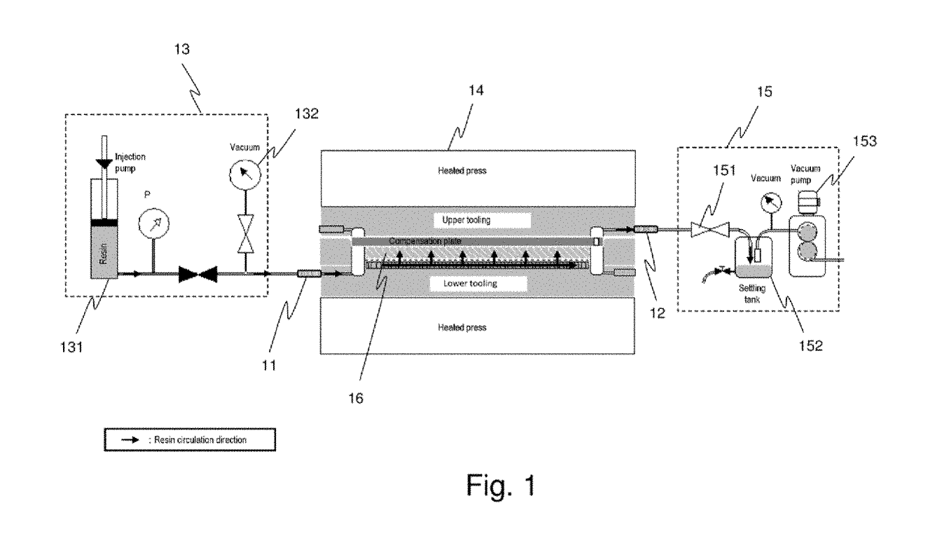

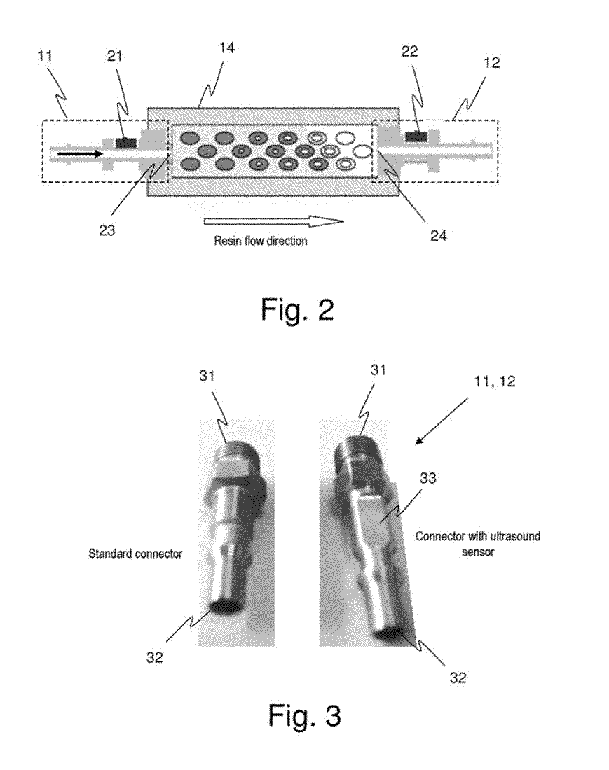

As FIG. 2 illustrates, the device according to the invention consists mainly in two ultrasound sensors 21 and 22 configured so as to be able to be integrated into a system for the injection of resin into an injection mold, so as to impregnate a preform positioned in that mold with the resin uniformly in terms of volume. FIG. 2 illustrates diagrammatically the principle of positioning the device according to the invention in the context of a conventional injection system, such as that illustrated by FIG. 1, notably including means 13 for injecting into a rigid mold 14 through an inlet port resin at a controlled temperature and a controlled pressure together with means 15 for recovering resin that has not been absorbed by the preform 16 that leaves the mold 14 through an exit port. The mold 14 is for example a fixed-volume RTM mold.

According to the invention, the ultrasound sensors employed are piezoelectric components able to function at a high temperature, typically at the resin injection temperature. The operating principle of these sensors is that of ultrasound echography based on relative measurements of amplitude (attenuation) and measurements of time delay (flight time) as well as on a frequency (phase-shift) analysis of the echoes of an emitted acoustic wave reflected by the various structures encountered during its passage within the thickness of the material being produced, placed in the mold.

Also in accordance with the invention, the ultrasound sensors are disposed as close as possible to the inlet and outlet ports of the injection mold so that no pressure or temperature drop can affect the pertinence of the measurements of the state of the flow of resin at the inlet and at the outlet of the mold.

According to the invention, the ultrasound sensors 21 and 22 are positioned as close as possible to the inlet 23 and the outlet 24 of the mold. In a preferred but non-exclusive embodiment of the device according to the invention illustrated by FIGS. 2 and 3 the ultrasound sensors 11 and 12 are respectively positioned in the connecting fittings 11 and 12 normally fitted to the inlet and outlet ports for the resin injected into the mold, the structure of which connecting fittings is seen to be modified compared to that of a standard connecting fitting so as to incorporate an ultrasound sensor and to ensure the operation thereof. In the embodiment illustrated by the view 3b of FIG. 3, the fitting shown includes between the end 31 intended to be mounted on the inlet or outlet port of the mold 13 and the end 32 intended to be connected to a resin feed pipe or resin recovery pipe a flat cavity forming externally a flat 33 and inside which the ultrasound sensor is housed.

A fitting according to the invention is generally made of steel. However, it can equally well be made of a refractive polymer, for example polyimide charged with graphite.

Refractory polymer fittings favor the propagation of the emitted ultrasound signal because of the closeness of their acoustic characteristics to those of the material to which the event to be quantified relates, notably epoxy resin. However, these fittings, although reusable nevertheless have a limited service life (because of wear). The low cost of manufacture/fitting is a material choice criterion here.

Thus the analysis of the reflected echoes as seen from the side of the inlet port 23 of the mold 13 and captured by the sensor 21 positioned at the level of the port 23 makes it possible to detect and to timestamp the events such as the presence of a flow of resin at the inlet of the mold 13 and the absence of porosity (i.e. of gas bubbles) in that flow of resin. This time stamping notably makes it possible to define a synchronization pulse triggering the starting up of the monitoring system responsible for the evaluation of the material-health of the impregnated object during the operation.

A monitoring system of this kind is for example a system constituted in known manner of various ultrasound sensors disposed inside the injection mold and the function of which is to determine by echography if the composite material being fabricated inside the mold features any structural anomaly. The published French patent application FR 2995556 filed by the applicant notably describes a “material health” monitoring system of this kind.

For its part, the analysis of the reflected echoes as seen from the side of the outlet orifice 24 of the mold 13 and captured by the sensor 22 positioned at the level of the port 24 makes it possible to evaluate the volume of resin injected (mold of fixed volume and volume of fibers determined as a percentage of that volume) as well as its quality (degassing) and thus to define the end of injection operation pulse as accurately as possible.

This end pulse is moreover intended to be compared with the information supplied by the sensors constituting the monitoring system situated on the upstream side of the mold 13 to determine as accurately as possible the time at which it can be considered that the impregnation of the preform is completed in order to stop the impregnation operation and to launch the operation of polymerization of the resin impregnating the preform.

In addition to the two fittings equipped with ultrasound sensors, the device according to the invention also includes means for analysis of the signals transmitted by the sensors, these means carrying out the analysis of the received signals to determine if the flow of resin at the location concerned is a stabilized flow. By a stabilized flow is meant a continuous flow of resin with no gas bubbles present. As indicated above, the analysis of the received signals consists mainly in a measurement of the variation over time of the amplitude of the echo received by the sensor concerned.

The determination of these amplitude variations notably makes it possible to determine at the level of the inlet of the mold the time at which the resin begins to pass through the fitting and the time at which the resin flows in a continuous stream (without bubbles) through the fitting (time T₀). In the same way it makes it possible to determine at the outlet of the mold the time at which the resin leaving the mold begins to pass through the fitting and the time at which the flow of resin through the latter becomes continuous (complete impregnation).

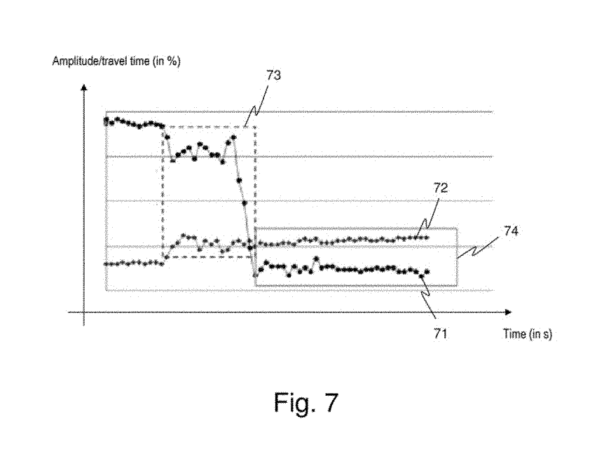

The principle of determination of the above times is illustrated by the FIG. 7 diagram, relating to the analysis of the echoes received by the sensor 21 positioned in the inlet fitting 11; this diagram can easily be transposed to the analysis of the echoes received by the sensor 22 positioned in the outlet fitting 12.

In this diagram, the curve 71 shows the variation over time of the travel time of the soundwaves in the fitting at the level of the inlet fitting 11 for times before and after the arrival of resin in the fitting and the curve 72 shows the variation over time of the amplitude of the soundwaves for the same times before and after the arrival of resin in the fitting.

For these two curves, the arrival of resin is characterized by a sudden inflection (zone 73 of diagrams 71 and 72). After stabilization of a flow of resin without bubbles each of the two curves has an easily discernible and substantially constant amplitude or propagation time value (zone 74 of diagrams 71 and 72).

As can be seen in FIG. 7, the time of starting of filling of the inlet fitting is easily identifiable by a variation of the amplitude of the signal corresponding to the curve 72 while the time T₀ (stabilized flow of resin) corresponds to the occurrence of a minimum on the curve 71.

From a functional point of view, and with the aim of optimum control of the impregnation process, as much in terms of impregnation quality (homogeneity, fiber content, etc.) as in terms of operation duration and quantity of resin used, the device according to the invention can advantageously be employed to carry out fine control of the process of impregnation of the preform.

To this end, the device according to the invention may be employed on its own or in association with the internal monitoring system equipping the injection mold and intended mainly to determine the material health of the composite material component produced inside the mold. The state of material health is a criterion generally resulting from echography measurements carried out by means of ultrasound sensors installed in the mold the echoes from which are analyzed and the analysis results compared to reference values, the agreement with the reference values making it possible to declare the part in a good state of health.

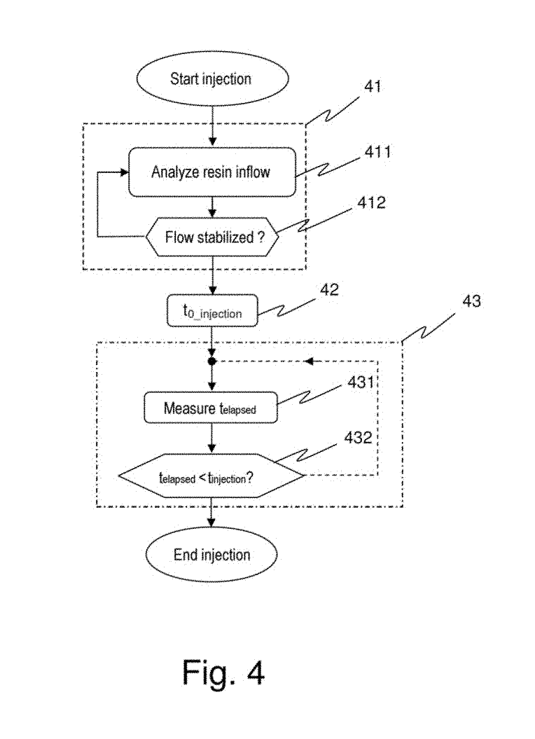

FIGS. 4, 5 and 6 describe the principal steps of different variants of a method of monitoring the completeness of impregnation operations employing the device according to the invention. This method described by way of example in different variants obviously does not constitute the only method of using the device according to the invention, and the scope of the device according to the invention is not limited to this use.

FIG. 4 describes the principal steps of a simple variant of a monitoring method employing monitoring of the appearance of a flow of resin at the outlet of the mold, for example a visual or optical check, and a measurement of time, here the time being counted from the time T₀ at which the analysis of the echo received by the sensor 21 of the device according to the invention situated in the inlet fitting 11 indicates a stabilized flow of resin.

In this variant, the monitoring method includes the following steps:
a first step 41 of launching the operation of injection of resin during which there is carried out an operation 411 of analysis of the flow of resin entering the mold, there is determined, 412, from the echoes received by the sensor 21 placed in the inlet fitting 11 of the mold if the flow of resin is a stabilized flow, that is to say a continuous flow;
a step 42 of initialization of a time t₀_{_}_{injection} of starting injection, this step being carried out as soon as the flow of resin entering the mold is considered as stabilized;
a third step 43 of monitoring the injection operation. In this variant, the third step merely consists in, while the injection of resin into the mold is continuing, carrying an operation 431 of measurement of the elapsed time, t_{elapsed}, that time being counted from the time t₀_{_}_{injection}, together with a comparison 432 of the elapsed time to a set point value t_{injection}. Then if the elapsed time exceeds the set point value the injection of resin is stopped and the impregnation process is considered as finished. The operation of polymerization of the preform impregnated with resin can then begin.

It should be noted that because the time of starting counting is determined by the device according to the invention, a more accurate measurement is available of the real duration of the injection of resin into the mold. Usually, in the absence of the device according to the invention, the duration of the injection generally has to be measured taking as the starting time the time of starting up the resin injection device 13.

Then, when the measured injection time reaches the reference value t_{injection}, it is generally obligatory to allow the injection to continue for a given further time lapse to take account of the difference that may exist between the time of starting injection (starting up of the device 13) and the real time of the beginning of penetration of the resin into the mold. In contrast, the use of the device according to the invention makes it possible to shorten if not eliminate this time lapse. This therefore achieves optimization of the injection time and economizes on resin.

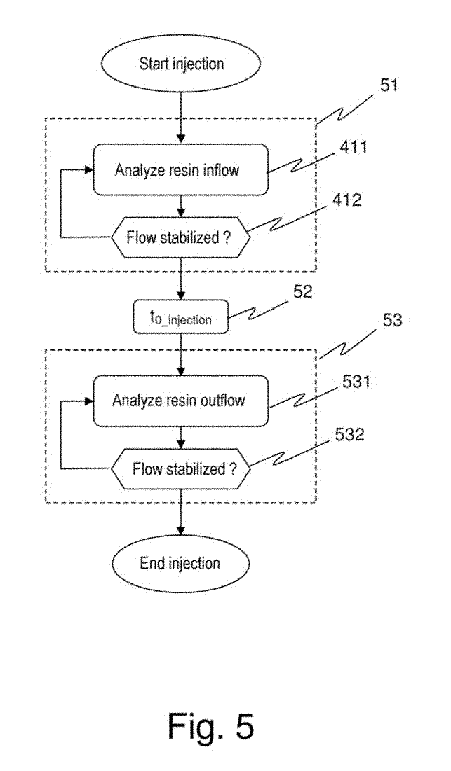

FIG. 5 describes the main steps of a monitoring method in a more sophisticated variant based on the analysis of the echoes received by the sensor 21 of the device according to the invention situated in the inlet fitting 11 of the mold 14 and by the sensor 22 situated in the outlet fitting 12.

In this variant, the monitoring method includes the following steps:
a first step 51 of launching the operation of injection of resin, similar to the first step 41 of the previous variant, during which there is carried out an operation 411 of analysis of the flow of resin entering the mold, there is determined, 412, from the echoes received by the sensor 21 positioned in the inlet fitting 11 of the mold if the flow of resin is a stabilized flow, that is to say a continuous flow;
a second step 52 of initialization of an injection start time t₀_{_}_{injection}, this step, similar to the second step 42 of the previous variant, being carried out as soon as the flow of resin entering the mold is considered as stabilized. In the context of this variant this second step may prove optional;
a third step 53 of monitoring the injection operation. In this variant, the third step merely consists in, while the injection of resin into the mold continues, carrying out an operation 531 of analyzing the flow of resin leaving the mold and determining (operation 532) from the echoes received by the sensor 22 positioned in the inlet fitting 12 of the mold if the flow of resin is a stabilized flow, that is to say a continuous flow.

Then, as soon as the flow of resin leaving the mold is considered as stabilized, the injection of resin is stopped and the impregnation process is considered as finished. The operation of polymerization of the preform impregnated with resin can then begin.

It should be noted that, in this variant, the determination of an event, other than a time measurement, characterizing the fact that the flow of resin leaving the mold is stabilized makes it possible to provide a stronger guarantee that, the mold being filled with resin, the preform housed in the mold is completely impregnated with resin. A variant of this kind, which exploits the information supplied by the two ultrasound sensors of the device according to the invention, therefore proves advantageously appropriate for ensuring the proper impregnation of a preform intended to produce a composite material component the fabrication quality of which is highly critical.

Without using the device according to the invention the impregnation of the preform to fabricate a component of this kind necessitates extending the injection time well beyond the theoretical time concerned.

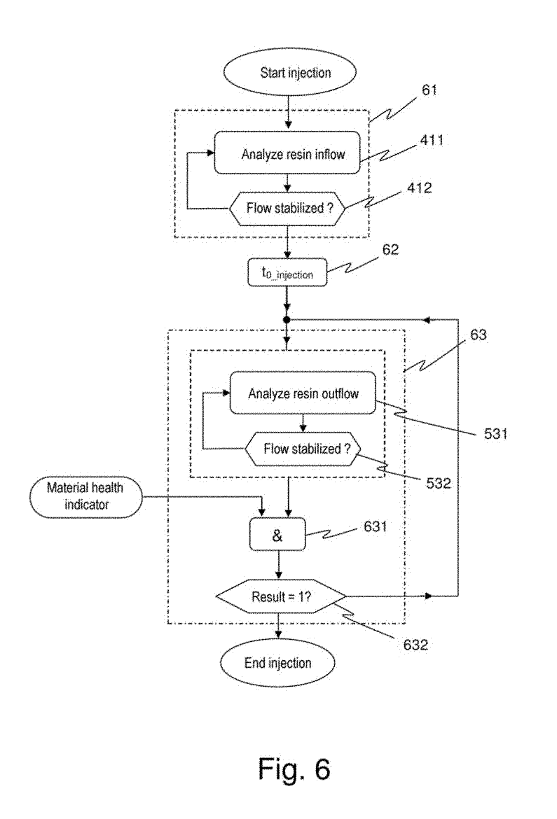

FIG. 6 describes the principal steps of a monitoring method in an even more sophisticated variant based on the analysis of the echoes received by the sensor 21 of the device according to the invention situated in the inlet fitting 11 of the mold 114 and by the sensor 22 situated in the outlet fitting 12, the result of this analysis being combined with the material health information supplied by the monitoring system integrated into the mold concerned.

In this variant, the monitoring method includes the following steps:
a first step 61 of launching the operation of injection of resin, similar to the first step 41 of the previous variant, during which there is carried out an operation 411 of analysis of the flow of resin entering the mold, there is determined, 412, from the echoes received by the sensor 21 positioned in the inlet fitting 11 of the mold if the flow of resin is a stabilized flow, that is to say a continuous flow;
a second step 62 of initialization of an injection start time t₀_{_}_{injection}, this step, similar to the second step 42 of the previous variant, being carried out as soon as the flow of resin entering the mold is considered as stabilized. In the context of this variant this second step may prove optional;
a third step 53 of monitoring the injection operation. In this variant, the third step consists in, while the injection of resin into the mold continues, carrying out an operation 531 of analyzing the flow of resin leaving the mold and determining (operation 532) from the echoes received by the sensor 22 positioned in the outlet fitting 12 of the mold if the flow of resin is a stabilized flow, that is to say a continuous flow.

It also includes simultaneously collecting from the material health monitoring system integrated into the mold information making it possible to determine if the structure of the component contained in the mold conforms to what is expected.

It then consists in effecting the merging 631 of the information relating to the stabilization of the flow of resin leaving the mold obtained by the operation 432, and to the good material health of the component.

Then, if the “stabilized flow” and “good material health” conditions are both satisfied in combination (operation 632), the injection of resin is stopped and the impregnation process is considered as finished. The operation of polymerization of the preform impregnated with resin can then begin.

It should be noted that the material health information delivered by the monitoring system integrated into the mold can take various forms that it is therefore necessary to consider and to process so as preferably to make available a simple indicator, for example of the “go-no go” or “0/1” kind, easily exploitable in the context of the method described here, as FIG. 6 illustrates. The synthesis of an indicator of this kind can depending on the circumstances be carried out either by the system responsible for monitoring material health or by the analysis means of the device according to the invention itself.

It should also be noted that this variant constitutes a sophisticated variant of the previous variant illustrated by FIG. 5. This variant makes it possible to take account of complementary information, useful in particular for determining whether continuing the injection operation under certain particular circumstances is well founded.

This is in particular the case if the material health monitoring system detects an area of the preform into which the resin is not able to penetrate. In a situation of this kind the material health indicator will assume a permanent “no-go” or “0” state indicating a structural anomaly of the component.

Then, although the flow of resin appears stabilized, the injection operation will be continued until, the zone concerned being finally impregnated, the material health indicator assumes a “go” or “1” state leading to stopping the injection operation. If despite the extension of the injection operation the zone concerned remains non-impregnated, then the material health indicator remains in a “no-go” or “0” state that can lead to stopping the injection operation at the end of a limit time lapse determined elsewhere.

Although the foregoing description elements rely on an application example concerning an RTM process involving a mold of fixed volume, the device according to the invention as has just been described can advantageously be used with various systems for injection of dry textile preforms of RTM and LRI type equally at a high temperature for the usual industrial applications or at room temperature as in the context of permeability benches. The functional characteristics of the device according to the invention are not commensurately modified, however.

Variants of the position of the device on a mold can nevertheless be induced by the nature of the mold or its operating principle, which variants can lead to modification/adaptation of the injection fittings.

This is in particular the case when fitting the device according to the invention to a mold of variable volume, such as LRI injection molds. In a context of this kind the resin outlet port may for example coincide with the vacuum suction port and the outlet fitting constituting the device be placed on that port.

Thus, the sensors can be installed so as to operate them in send/receive mode or in transmission mode.

Similarly, the fittings can be modified in terms of design as much where this concerns the material used (metal in the standard manner or refractory polymer (more costly)), the presence of zones machined or modified specifically to favor the propagation of longitudinal or transverse waves, or a structural optimization linked to the configuration of the injection tooling used (for example multipoint injection).

Moreover, the installation of the ultrasound sensor in the fitting can have various specific features. Accordingly:
the connectors associated with the sensors can be designed to be removable and reusable (encapsulation device);
the installation can be of diverse kinds and either without contact with the injection fluid, the body of the fitting serving as a relay for the soundwaves, or with direct contact with the injection fluid, the sensor being mounted by drilling and immobilization in the fitting.

The sensitive component, the sensor, can furthermore be mounted on a machined area and fixed by gluing.

The sensitive component may further consist in a deposition of material by spraying (piezo-spraying), the material being cured on the fitting.

1-8. (canceled)

9. An ultrasound device to characterize a flow of resin entering and leaving an injection mold during a phase of impregnation by the resin of a preform contained in the injection mold, the ultrasound device comprising two ultrasound sensors arranged respectively in a vicinity of an inlet port where the resin enters the injection mold, outside the mold, and in a vicinity of an outlet port where the resin leaves the injection mold, each sensor emits an ultrasound wave towards an end of the injection mold in the vicinity of which said each sensor is positioned and receives the ultrasound wave reflected by a medium.

10. The ultrasound device as claimed in claim 9, wherein the ultrasound sensors are integrated into a structure of fittings to connect the injection mold to an injector to inject the resin into the injection mold and a recovery monitor to recover the resin evacuated from the injection mold.

11. The ultrasound device as claimed in claim 9, further comprising an analyzer to at least one of temporally analyze or spectrally analyze the ultrasound wave received by said each sensor and to determine a stabilization of the flow of the resin through the injection mold.

12. The ultrasound device as claimed in claim 11, wherein the injection mold comprises a material health monitor inside the injection mold to monitor a material health of a part formed from the preform; and further comprising a detector to determine a completeness of the impregnation of the preform by combining information supplied by the analyzer and information supplied by the material health monitor.

13. A method for determining a completeness of an operation of impregnating a preform with a resin, the preform being positioned in an injection mold into which the resin is introduced, the method employing the ultrasound device as claimed in claim 9 and comprising steps of:
launching an operation of injecting the resin during which an operation of analyzing a flow of the resin entering the mold is performed;
initializing an injection start time; and
monitoring the injection operation by employing an operation of measuring an elapsed time, the elapsed time being measured from the injection start time, and comparing the elapsed time to a set point value.

14. A method for determining a completeness of an operation of impregnating a preform with a resin, the preform being positioned in an injection mold into which the resin is introduced, the method employing the ultrasound device as claimed in claim 9 and comprising steps of:
launching an operation of injecting the resin during which an operation of analyzing a flow of the resin entering the mold is performed;
initializing an injection start time; and
monitoring the injection operation by employing an operation of analyzing an exit flow of the resin leaving the mold, the injection operation is stopped in response to a determination that the exit flow of the resin has stabilized.

15. The method as claimed in claim 14, wherein the monitoring step further employs an operation of analyzing a material health of a part formed from the preform inside the mold, the injection operation is stopped in response to the determination that the exit flow of the resin has stabilized and that the material health is positive.

16. The method as claimed in claim 15, wherein the injection operation is continued in response to a determination that the material health remains negative during the monitor step while the exit flow of the resin has stabilized since at least a predetermined time lapse; and wherein the injection operation is then stopped at an end of a limit time lapse in response to the determination that the material health remains negative despite lengthening of the injection operation.
